(19) United States
(12) Patent Application Publication
(10) Pub. No.: US 2008/0283548 A1
(43) Pub. Date: Nov. 20, 2008

(54) Dispensing Apparatus

(76) Inventor: Duncan McKenzie Miller, Huntly (NZ)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/916,654

(22) PCT Filed: Aug. 31, 2006
(86) PCT No.: PCT/NZ2006/000226

§ 371 Date: Jul. 9, 2008

(30) Foreign Application Priority Data
Aug. 31, 2005 (NZ) 542163

(51) Int. Cl. G07F 11/00

(52) U.S. Cl. 221/124

(57) ABSTRACT

This invention relates to dispensing apparatus for dispensing a variety of a similar item. The dispensing apparatus includes a cabinet, being adapted to enclose multiple compartments. Each compartment is capable of retaining multiple substantially similar beverage items. The dispensing apparatus also includes dispensing trigger means to trigger release of a preferred item and at least one delivery port where the item is delivered for collection. The dispensing apparatus further includes dispensing control assembly configured to offer at least one service from a range of services as defined. The beverage items dispensed include miniature bottles capable of holding up to or more than 50 millilitres of a beverage.

### TECHNICAL FIELD

The present invention is directed to improvements in and relating to dispensing apparatus. This invention particularly relates to a vending machine and more specifically to a vending machine for dispensing miniature or small bottles of a beverage, such as individual miniature bottles of alcohol. In effect, the dispensing apparatus provides a minibar.

It is envisaged the invention will have particular application in relation to the hospitality industry, particularly in hotels, motels, bars, clubs and the like, where customers may wish to avail themselves of the smaller or miniature bottles of alcohol, or small quantities of a range of beverages.

In addition, the invention relates to a dispensing or vending machine for miniature bottles where the dispensing machine also includes a control dispensing assembly for controlling any one or more of a web-cam/audio security recording system, wireless advertising display system, trouble-shooting feedback, breath testing, networking (wireless or otherwise) and data storage facilities and so forth.

### BACKGROUND ART

A range of vending machines and apparatus exist in the prior art for dispensing a wide variety of products. Such products range from packets of cigarettes, single cigarettes, food items, cans of beverages, cups of coffee, candy and the like. However, the dispensing of miniature beverage bottles, such as the kind used for selling miniatures of alcoholic drinks have not typically been considered for use with such dispensing apparatus. The size of the bottles and the range of options for beverages in such bottles means that current beverage dispensing apparatus is not designed to accommodate and dispense this type of product.

Many hotels, motels and the like offer a minibar system which is available within a refrigerator located in the room booked by an individual. However, such systems rely on the recording of items being used by the individual, require daily monitoring of the contents of the refrigerator, and may only provided a limited range of beverages, which may not appeal to the individual. Honesty of customers, ensuring appropriate age of customers drinking available alcoholic beverages and so forth can not so easily be monitored within the parameters of this system.

In addition, some hospitality industries may offer larger bottles of beverages, or only beverages by the glass. Where an individual wishes to consume only a small amount of alcohol, or wishes to consume the beverage in the privacy of their room, having access to smaller bottles (such as the 50 ml miniature bottles) of various alcoholic beverages or non-alcoholic beverages may be preferred.

Conventional vending machines for small items may be required to hold a reasonable quantity of a product so that they do not need to be serviced too often. As such, they may be large and occupy a reasonable floor area. This may be less desirable for hotels where space is a premium and offering such dispensing systems on individual floors may not be a practical consideration.

Some vending machines may only offer a lot of different products but offer only a few alternatives. Alternatively, some machines may be adapted to carry a wide variety of only one type of item (such as cigarettes) but provide the customer with the ability to select say between many different brands of cigarettes, for example. Few systems offer the option of the potential for a wide range of beverages and at the same time have the capacity to hold a reasonable quantity of each type.

Reloading of a machine can be a time and labour consuming process involving individually inserting items, checking unsold items for expiration date and inventory purposes, cleaning of the station, and collecting and counting cash, often manually by the individuals servicing the machine. Various dispensing machines are configured to accommodate the particular items being dispensed and are therefore not so readily adaptable to accommodate other products.

Most of the dispensing machines have a front panel. In some machines the front panel of the machine may be clear to enable the individual to view the selection. Alternatively, the front panel may be coloured or patterned to attempt an aesthetically pleasing aspect, may be opaque and blank, or may contain pictures of the items able to be dispensed.

As the machine is typically available for use in a particular establishment, it may be useful to have at least a portion of the front panel of the machine being used to display something relevant to the establishment, its location, its get-up, a promotional theme and so forth.

Further, one area of concern may be the security aspects of the dispensing machine. Where money is used to obtain the items, or the items are high value or desired goods, there is the risk of damage and theft of money and items from the machine. Vandalism for the sake of vandalism is also a concern where apparatus is left in a location unattended for any length of time.

Typically the front panel is not adapted to be connected to a network system through which items may be shown on the front panel as advertising or to promote a scenic location etc. Further, such panels are not typically adapted to be used in association with web/cam facilities and the like for providing networked security systems for the vending machines.

A compact, simplified machine which could operate to provide a consumer with many types of a uniformly packaged item (such as 50 ml miniature beverage bottles), would enable the preferences of a number of individuals to be accommodated.

A dispensing machine having multiple magazines or having a plurality of hoppers each containing a queue of dispensable items and each hopper providing the consumer with another alternative to choose from would also enable the preferences of a number of individuals to be accommodated.

Further, a dispensing machine which included other features, such as a webcam or audio security system, operated a wireless advertising system, or was able to process information as to sales of the items by volume, type and value and provide feedback to the servicing personnel with respect to consumer preferences, and so forth, would offer a dispensing apparatus having greater versatility and commercial value than many currently existing options.

It would be useful therefore, to have dispensing apparatus that:
a) Could accommodate a wide range of alcoholic beverages as 50 ml miniature bottles; and b)
c) Could be made from an adapted dispensing machine to minimise costs, or could be custom built; and
d) Could enable a reasonable quantity of each variety of beverage to be available for dispensing; and
e) Could dispense via the use of cash, chips, credit or ATM cards, or other smartcards; and where smartcards are used
f) Could be used to collate information as to the number of items purchased by a particular user of the card, the cost per item and the overall cost and relay that to a central charging facility, such as a hotel or motel reception for payment by the individual on checkout; and
g) Was securely configured, being lockable and optionally incorporating a security system such as a webcam and/or audio security system to not only provide security to the dispensing machine, but also offer a security system for the hotel/motel or patron where the machine is housed. Given concerns about under-aged drinkers, such a web cam networked to the hotel reception or a central processing point could operate as a watchdog against such incidences; and
h) Was easy to use; and
i) Incorporated a microprocessor to provide feedback on a range of parameters associated with the dispensing machine, such as temperature, usage, preferred beverages, damage alerts, refilling alerts and so forth; and
j) Could be automated, semi-automated or manual with respect to some of its functions; and
k) Could provide an opportunity for advertising, including static images, or short video clips which could be used to advertise the premises or location of the machine; and/or could be used by other businesses. Charges from such advertising could provide a source of income from the vending machine; and
l) Given concerns about drinkers who then drive, it would be potentially beneficial to include within the network a breath testing system so customers can obtain a read out of their breath alcohol level as a warning against driving; and
m) Having regard to use of the machine by underage persons, the accessibility to the products of the machine could be limited via security means directed to only enabling access by verified users of the machine.

It would therefore be advantageous to have an invention that offered at least some if not all of the advantages of the above proposed dispensing apparatus. Ideally the present invention will also provide a system which allows for substantially trouble free installation and use.

It is therefore one object of the present invention to consider the above problems and provide at least one solution which addresses a plurality of these problems.

It is also a further object of the present invention to at least provide the public with a useful choice or alternative system.

Further aspects and advantages of the present invention will become apparent from the ensuing description which is given by way of example only.

It should be appreciated that variations to the described embodiments are possible and would fall within the scope of the present invention.

### DISCLOSURE OF INVENTION

The present invention will now be described with considerations for establishing dispensing apparatus capable of functioning as a minibar system. The ensuing description will also consider the use of pre-existing dispensing apparatus which could be adapted to accommodate and operate the preferred minibar system, as well as the manufacture of custom-made dispensing apparatus.

According to one aspect of the present invention there is provided dispensing apparatus for dispensing a variety of a similar item, said dispensing apparatus including a cabinet, said cabinet being adapted to enclose multiple compartments, each compartment capable of retaining multiple substantially similar items; said dispensing apparatus also including dispensing trigger means to trigger release of a preferred item and at least one delivery port where the item is delivered for collection, said dispensing apparatus further including dispensing control assembly characterised by offering at least one service from a range of services as defined herein.

According to another aspect of the present invention, there is provided dispensing apparatus substantially as described above wherein a separate compartment is provided for accommodating beverage containers, and wherein the beverage containers are miniature bottles capable of holding at least 50 ml of a beverage.

In preferred embodiments, the item is a range of different miniature 50 mil beverage bottles, such as miniature alcoholic beverages. As can be appreciated there may be any one of many alcoholic beverages bottled in the 50 ml miniatures, and equally a range of non-alcoholic beverages.

According to another aspect of the present invention, there is provided dispensing apparatus substantially as described above wherein each compartment is of either or both a width and a length to approximately correspond to either or both the width and the length of the beverage container.

The storage compartments may be formed from a material such as sheet metal and may be constructed with cross sectional length and width dimensions that allow the individual items to be retained within the magazine but to move easily within the compartment as required when being dispensed. The compartments are provided with an outlet opening and an inlet opening. In operation the compartment may be mounted in an approximately vertical position with the inlet opening located higher than the outlet opening so that the item may roll by gravity from the inlet to the outlet; or substantially horizontally, but inclined to aid dispensing of the items.

According to another aspect of the present invention, there is provided dispensing apparatus substantially as described above wherein the beverage container can be deposited in the compartment substantially horizontally with their longitudinal axis and at a right angle to the side walls of the compartment or any intermediate walls of the compartment.

According to another aspect of the present invention, there is provided dispensing apparatus substantially as described above wherein the beverage container can be disposed in the compartment substantially vertically with their longitudinal axis parallel to the side walls of the compartment or any intermediate walls of the compartment.

According to another aspect of the present invention, there is provided dispensing apparatus substantially as described above wherein the height of each compartment enables a plurality of beverage containers to be arranged in a stacked relationship, one beverage container being substantially adjacent to at least one other beverage container.

Depending on the configuration of the compartments, the beverage containers may be stacked one on top of another, or stacked one behind another, or be stacked one alongside another, but in any event are queued to be dispensed in order of arrangement. The stacking arrangement is designed to enable a single beverage container to be dispensed to the delivery port at a time. The inner diameter of the compartment is selected to closely match the diameter of the item while allowing free movement of it through the compartment for dispensing.

According to another aspect of the present invention, there is provided dispensing apparatus substantially as described above wherein the cabinet comprises two spaced apart planar surfaces forming a front and a back wall of the cabinet, two additional planar surfaces at right-angles to the front and back walls and thereby forming side walls of the cabinet, and a further two planar surfaces forming a top and a bottom of the cabinet.

The cabinet of the dispensing apparatus has a generally rectangular outer peripheral configuration and a generally rectangular cross-sectional configuration with two parallel spaced sidewalls and two parallel spaced end walls and a top and a bottom.

The cabinet is substantially of a height, width and depth required to accommodate the compartments, items, dispensing trigger means and delivery port, along with any security means, locking means, electronic systems, illumination and the like. For example, a lighting display may be mounted and energized in the stand portion or the cabinet.

In operation the dispensing apparatus for dispensing individual items is configured to comprise a cabinet with a lockable door and at least one elongated storage compartment sized to retain a plurality of stacked substantially cylindrical items. The cabinet has a back wall and side walls and top and bottom walls. Inner partitions may separate adjacent compartments.

According to another aspect of the present invention, there is provided dispensing apparatus substantially as described above, wherein the cabinet includes a stand integral with or adapted to be connected to the cabinet.

Preferably, the stand raises the cabinet (off the ground or other surface on which it may be standing) to a more appropriate height for use, without including the bulk of extending the cabinetry. In some embodiments however, the cabinet may be affixed to a wall and the stand may not be required. According to another aspect of the present invention, there is provided dispensing apparatus substantially as described above wherein at east one of the surfaces of the cabinet is removable to gain access to the interior of the cabinet.

Entry to the cabinet is required for stocking the cabinet, clearing any money, or attending to cleaning or repair.

According to another aspect of the present invention, there is provided dispensing apparatus substantially as described above wherein the cabinet includes locking means.

Preferably, the locking means is designed to restrict entry to the cabinet to only authorised personnel as required for stocking the cabinet, clearing any money, or attending to cleaning or repair. Thus the locking means minimises theft from the cabinet of the items themselves, or money or chips used to purchase the items.

According to another aspect of the present invention, there is provided dispensing apparatus substantially as described above wherein the cabinet also optionally includes security means.

Preferably, the security means is in the form of a webcam, audio-security system, tamper alarm and so forth. Given concerns about theft, vandalism underage drinking, the web cam could operate in conjunction with a wireless or wired network, which would enable an individual at a reception of a hotel or at a central processing location to monitor the feedback from the web cam. Accordingly, there would be a clear image of the person purchasing items from the machine. An audio system could be similarly of potential benefit and would also enable the individual receiving the audio message to provide feedback or assistance to the consumer via the vending machine's systems. A tamper alarm is a useful option when providing a deterrent against vandalism to or theft from the machine.

According to another aspect of the present invention, there is provided dispensing apparatus substantially as described above wherein the cabinet the front wall of the cabinet may be transparent.

A transparent front wall may be preferred to enable static advertising to be displayed therethrough, to enable display of the items and so forth. However, in other embodiments the front wall may include a screen capable of receiving video, CD or film images for advertising purposes or general entertainment. Images transmitted to the front wall would enable the front wall to operate as a screen for displaying such advertising. The ability to feed such images to the screen via a control centre or an in-house operator enables the advertising to be controlled for set time periods. Such advertising could be run for a payment which would provide an additional source of income from the vending machine.

Alternatively, the front wall may be appropriately and aesthetically coloured as required.

In addition, the front panel will preferably include brand and price displays providing such details to the consumer making a selection. For example, the brand display may be a descriptive of a banked array, such as “Premium Spirits”, “Bourbons”, “White Spirits” “Scotch Whiskeys”, “Dark Spirits” and so forth. Alternatively or in addition, a picture of a miniature bottle having the label of a particular alcoholic beverage, such as “Jim Beam”, “Jack Daniels” and so forth may be included.

The brand indicating panel and closure wall may be interchangeable.

According to another aspect of the present invention, there is provided dispensing apparatus substantially as described above wherein the front wall of the cabinet includes at least one dispensing port.

Preferably, the dispensing port is in the portion where the front wall and the bottom of the cabinet come together. The bottom of the cabinet may be arranged to include an inclined plane which slopes in the direction of the delivery port or opening in the front wall of the cabinet.

According to another aspect of the present invention, there is provided dispensing apparatus substantially as described above wherein the dispensing apparatus includes a funds register.

Preferably, the funds register is at least one suitably configured slot arranged in any accessible surface of the cabinet and which is capable of receiving money, currency chips, or electronic smart card and so forth. There may be one funds register per compartment, or one funds register per dispensing apparatus.

The funds register may also be linked to an integrated network, whether wireless, or not. The funds register could be used to further identify the purchaser of the items, particularly if the machine provided the option for use of a smart card or the like. In combination with the webcam security, the system would offer a back up to ensuring under aged people were not using the machine, or were using it only for non-alcoholic options. Further, should the smart card have been stolen, the networked system may be used to identify the thief. Where notification of theft has been received, the networked system could operate to prevent an unauthorized user accessing the items.

By depositing the funds into the funds register the machine may activate the dispensing trigger. Alternatively, receipt of funds in to the funds register may be the dispensing trigger. In yet other embodiments depositing funds in the funds register may simply unlock the dispensing trigger enabling it to be activated, such as for example, allowing the user to push a dispense button or pull on a dispensing lever, or the like.

If coins are used, the funds register may be a substantially U-shaped coin inlet slot and may include a coin guide chute to allow a coin or chip to roll into a coin box. The inlet slot and guide may be sized to allow only appropriately sized coins or chips to be inserted. Where a smart card or similar is used, the funds register may be an appropriately shaped slot conforming to the dimensions of the card.

In any event depositing funds in to the funds register leads to operation of a gate mechanism which opens for a defined period or defined distance and allows a single beverage container to be released from the its compartment and towards the delivery port. The gate mechanism may be mounted adjacent the outlet opening of the compartment and operates to retain or discharge the items from the compartment.

A number of mechanisms exist in the prior art to activate the dispensing cycle. For example, pushing a dispensing button may energize a solenoid which drives a rocking gate mechanism associated with each compartment to discretely and selectively drop the chosen item toward the delivery port. Alternatively, a lever mechanism may manually release the gate mechanism—opening it to allow the beverage container to be released from its compartment. In yet another embodiment a pneumatic system may be employed which would effect opening and closing of the gate mechanism for dispensing the item. All such systems may be similarly integrated with the system network for optimum performance of the vending machine and for providing feedback of information to a database where the information is analysed and used for various purposes, whether to monitor sales pr machine, choices, and so forth. Such information in return could enable more useful placement of the machines, provide better return from advertising, determine preferred beverages, optimum times of sales and so forth. Where the advertising is linked to a product being sold, the success of the advertisement may also be monitored.

The dispensing apparatus may also include a chute extending from the level of the lower end of each compartment to the delivery port to facilitate dispensing of the beverage container located next in line for dispensing from the particular compartment containing the selected beverage.

Preferably the dispensing apparatus includes dispensing triggers for individually actuating each of the compartments and an electronic dispensing control assembly. To assist in this function there are as appreciated, associated power supplies, a currency or smart card acceptor or electrical connection to an associated accounting device equipped to communicate payment registration feedback to the dispensing trigger and/or gate mechanisms.

The gate mechanism may be located in a lower portion of the compartment and is closed in an at rest state preventing the downward or forward movement (generally under gravity) of an item in the queue. When the gate mechanism is actuated it moves to a second position where items in the queue move downwardly or forwardly (generally due to gravity) resting against the first item and allows the first item in the queue to freely fall or move through the gate opening, out of the compartment and on towards the delivery port.

Electric signals, in visual or auditory form (such as a flashing light, an LCD display, a buzzer or tune), may trigger the dispensing of the article from the discharge gate.

When the dispensing apparatus is operated and the items are dispensed, the act of dispensing may be as described above, via gravity feed, or in some embodiments may be motor driven, or may be delivered by the operation of a pneumatic delivery system.

The dispensing apparatus may be loaded from the top or thru access doors in the front or rear of the cabinet, depending on the configuration of the cabinet.

The dispensing apparatus is preferably able to dispense the items continually, as required through purchase, with little hands on maintenance.

The dispensing apparatus may be built from any suitable material including, but not limited to ferrous or nonferrous metals, a combination of both, thermoplastics, acrylics or wood. The exterior may be powder coated, painted, varnished, electroplated and so forth as required to obtain the desired finish.

According to another aspect of the present invention there is provided dispensing apparatus including dispensing control assembly, said dispensing control assembly including a microprocessor programmed to control one or more from a range of preferred services.

For the purpose of this specification the services offered by the dispensing control assembly include, but are not limited to: the operation of the funds register; generation of the signal allowing the user to activate the dispensing trigger; the operation of the gate mechanism; release of the selected item; programming of the price and location of the item; down-loading of sales records; currency deposited in the funds register to be credited to the user smart card from which current and later purchases can be debited; controlling of the operation of multiple inter-connected dispensing apparata within the one location/hotel; provision of remedial feedback to any apparatus in instances of malfunction; downloading and comparative analyses of performance based on location, consumer preferences and so forth using data from a single dispensing apparatus or a number of dispensing apparata; security and/or alarm systems including webcam or other visual surveillance and/or auditory systems; advertising displays.

Programming of appropriate software and use of relevant hardware may also allow and enable control of a system for connecting dispensing services to a network and includes at least one of: a user interface service in operative connection with the network; transaction services such as a reader service also in operative connection with the network. The user interface service is operative to locate transactions and dispensing on the network by invoking a remote lookup service. The user interface service is further operative to invoke methods for remotely controlling the functionality of the dispensing services on the network and for notification when certain events affecting the dispensing services occur.

Prior art control systems for dispensing or like machines have typically included mechanical and electromechanical means. Such means include levers, relays, cams, springs and the like. Progression to the use of electronic components, including integrated circuits, offers improved reliability, but has typically been limited to the range of functions able to be performed, or the extent of functionality.

However, with the advent of advanced integrated circuit technology, microprocessors and so forth increased control systems having greater flexibility, greater functionality and more efficient and cost-effective processing have become possible.

The control system of the present invention therefore is preferably a computer or microprocessor, cooperating with an encoder circuit for specific functions and which in turn is programmable. Interfacing circuits between the computer or microprocessor and other elements of the control system and of the vending machine itself are also provided.

According to another aspect of the present invention therefore, there is provided dispensing apparatus linked to a network, said dispensing apparatus including: a processor; said network in operative connection with the processor; and software component stored in operative connection with the processor, wherein the processor is operative to communicate with at least one other dispensing apparatus, and wherein the processor is responsive to feedback from at least one other dispensing apparatus and/or the network.

Accordingly, the dispensing apparatus individually or when connected to a network preferably includes: a processor; a data store in operative connection with the processor, a lookup service and a data store associated with the lookup service.

Accordingly, in preferred embodiments, the control system may be adapted to accept a monetary unit allowing the pricing of items to be readily altered to accommodate different prices; may enable use of coins, notes and/or smart cards and may be altered by the user to change the prices of any article, as well as to accept monetary units of different values or in a different monetary system and enable selection of a change or refund request.

Briefly, in operation the control circuit may be programmed to be responsive to appropriate signals received, for energizing displays and relevant driver circuits for dispensing the item, for conversion of a predetermined value of an item in accordance with a selected monetary system, for reporting that credit available on a smart card is insufficient for the item selected, or is insufficient for a refund.

In one embodiment of the present invention, the control system may be comprised of, or include any one or more of the following:

A card reader, a mainboard, a Processor (such as a Pentium 1000 with preferably up to or more than 128 MB memory), a Network card (wireless), a video card (having say 64 MB memory), an audio card, speakers built in to the machine, a hard drive of 20 GB or better, a video screen, a web camera, a breath analyzer. If the system was used in a hotel, the local network would require a 1DSL Modem and internet connection (or better), network cabling to each floor to connect the wireless receiver, a stock of items and advertising media.

It should be appreciated that the present invention lends itself to more than one application. Hence, the invention may be adapted through a change to one or more, or a combination, of any dimensions, numbers of items, types of item, security systems, advertising systems, control systems and so forth. As can be appreciated variations to and from the above described embodiments may be made without deviating from the scope of the present invention.

It should further be appreciated a variety of different embodiments, uses, and applications of the present invention therefore exist, even within the ambit of the above described lifting apparatus system. Various embodiments of the present invention will now be given by way of example only, to help better describe and define the present invention. However, describing the specified embodiments should not be seen as limiting the scope of this invention.

### BRIEF DESCRIPTION OF DRAWINGS

Further aspects of the present invention will become apparent from the following description, given by way of example only and with reference to the accompanying drawings in which:

FIG. 1 is a front view of the dispensing apparatus in accordance with one preferred embodiment of the present invention; and

FIG. 2 is a side view of the dispensing apparatus of FIG. 1 in accordance with that preferred embodiment of the present invention; and

FIG. 3 is a front perspective view of the dispensing apparatus of FIG. 1 in accordance with that preferred embodiment of the present invention, but illustrating the possibility of advertising and brand or item identification.

### BEST MODES FOR CARRYING OUT THE INVENTION

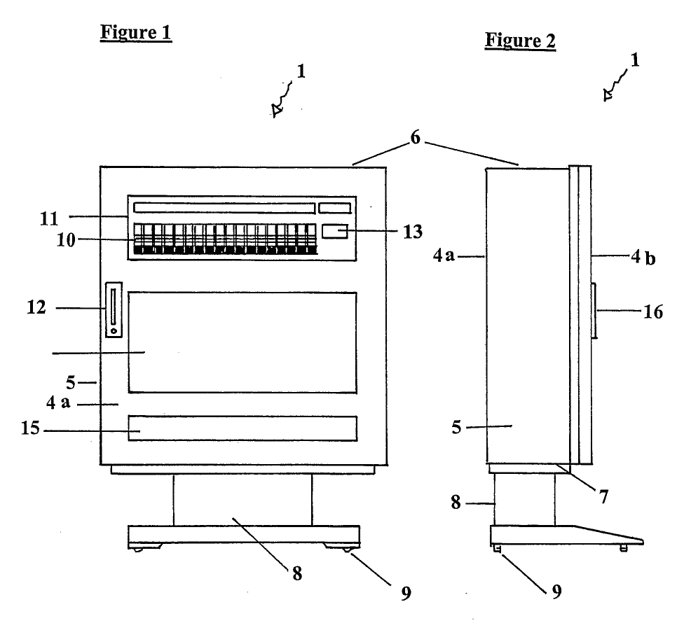

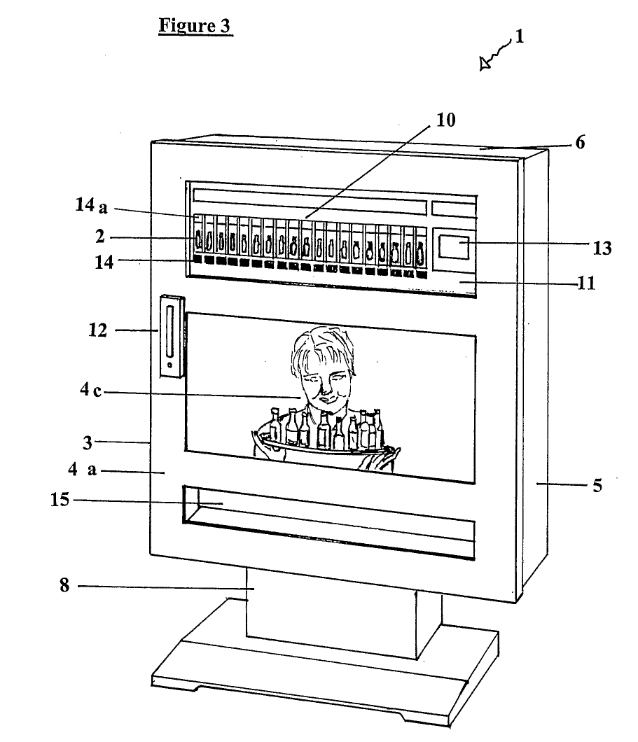

With reference to the diagrams (FIGS. 1 to 3) by way of example only, there is provided dispensing apparatus (generally indicated by arrow 1) for dispensing a variety of a similar item, such as 50 ml miniature bottles of alcohol or other beverages as illustrated in FIG. 3 (at (2)).

The dispensing apparatus includes a cabinet (3). The cabinet has a generally rectangular outer peripheral configuration and a generally rectangular cross-sectional configuration with two parallel spaced sidewalls (front wall 4a and back wall 4b), two parallel spaced end walls (5) and a top (6) and a bottom (7) as shown in FIGS. 1 to 3.

Any of the walls or the top may include locking means, may be hinged to enable entry to the cabinet interior. The front wall may include user specific or item specific promotional material (as shown at 4c) and may be illuminated.

The cabinet may be integral with or adapted to be attached to a stand (8). The stand may include wheels (9) or other motive means to facilitate the moving of the dispensing apparatus between preferred locations.

The cabinet encloses multiple compartments (10), which although not shown are represented on the display panel (11). Each compartment is capable of retaining multiple items.

The dispensing apparatus also includes dispensing trigger means to trigger release of a preferred item. In the embodiments represented by FIGS. 1 and 3, the dispensing trigger means includes a fund register slot (12) for receiving coins, notes, chips or cash/smart cards; and a dispensing button (13). The operation of the dispensing trigger means results in a gate mechanism being operated from a closed to an opened position enabling a selected item to be dispensed. To choose which item is required, the dispensing apparatus includes selection means (14) corresponding to the options available and displayed on the display panel (11) and price indicators (14a).

The dispensed item moves from the item compartment towards at least one delivery port (15) where the item is delivered for collection.

The dispensing apparatus further includes dispensing control assembly characterised by offering at least one service from a range of services as previously defined herein.

The invention may be adapted through a change to any particular feature. As will now be exampled by describing three varying embodiments.

### EXAMPLE 1

This description relates to a change model—offering the capacity for use of coins, chips or notes and providing change for excess payment. Accordingly, an electronic coin acceptor is standard. This model may offer a selection of thirteen different beverage options. All beverages are in 50 ml miniature bottles. The compartmentalization enables 247 bottles to be stored in the dispensing apparatus.

Each compartment includes a single individual drive. The single drive enables disabling of only one compartment in case of jamming bottles.

The cabinet is made of steel and may be painted or powder coated in any colour, but preferably in colours which will blend in with colour schemes at any location—such as brown/beige/white.

The cabinet includes vandalism protection by reinforced areas, close fitting panels and so forth. It also includes a central lock with six-fold locking option.

The front wall includes an illuminated display window for advertising, or other material. An illuminated display panel is also provided which illustrates the multiple configurations for “banked arrays” of items—such as grouped options comprising “Premium Spirits”, “Bourbons”, “White Spirits” “Scotch Whiskeys”, “Dark Spirits” and so forth, the brands and the prices.

Alternatively, or in addition, a picture of a miniature bottle having the label of a particular alcoholic beverage, such as “Jim Beam”, “Jack Daniels” and so forth may be included.

The dimensions of the cabinet will approximate 79.5 cm overall width with the illuminated front wall being approximately 61.5 cm wide and 43 cm high; the height of the dispensing unit is approximately 130 cm of which 28.5 cm is attributable to the stand; and the depth of the cabinet is approximately 33.2 cm overall.

### EXAMPLE 2

This version of the dispensing apparatus includes all of the features of Example 1, but is adapted to have a capacity for only 10 compartments for item selection and therefore offers an overall capacity of 210 bottles of beverage.

Being a smaller version, the width dimensions are approximately 67.5 cm overall, whilst the front wall display window is similarly reduced to 49.5 cm.

This smaller version may be preferable in locations where available space is a premium.

### EXAMPLE 3

This version of the dispensing apparatus again includes all of the features of Example 1, but is adapted to have a capacity for 19 compartments for item selection and therefore offers an overall capacity of 418 total bottles of beverage.

Being a larger version, the width dimensions are approximately 93.5 cm overall, whilst the front wall display window is similarly extended to 73.3 cm.

This larger version may be preferable in locations where space is available and customer demand is high.

### Operational Features

The operational features for any of the above examples include clearly arranged touch pad selection buttons positioned in association with the display panel and corresponding to the items available for selection. In addition, there is a coin insertion indication, compartment empty indication, and correct insertion indication (ie no change indication).

The dispensing apparatus is powered by 110-240 volt energy supply, with a secondary low voltage electronic control/microprocessor with memory.

Optional features include a change giver, an alarm system, a high security cash box, an alphanumeric display, adapting device (which can be attached for example at 16) for wall mounting and customised stock configuration.

In addition, any of the versions of the dispensing apparatus can include variations to the control assembly. As previously indicated, the services offered by the dispensing control assembly include, but are not limited to: the operation of the funds register; generation of the signal allowing the user to activate the dispensing trigger; the operation of the gate mechanism; release of the selected item; programming of the price and location of the item; down-loading of sales records; currency deposited in the funds register to be credited to the user smart card from which current and later purchases can be debited; controlling of the operation of multiple inter-connected dispensing apparata within the one location/hotel; provision of remedial feedback to any apparatus in instances of malfunction; downloading and comparative analyses of performance based on location, consumer preferences and so forth using data from a single dispensing apparatus or a number of dispensing apparata; security and/or alarm systems including webcam or other visual surveillance and/or auditory systems; advertising displays; and breath analysis.

Programming of appropriate software and use of relevant hardware may also allow and enable control of a system for connecting dispensing services to a network and includes at least one of: a user interface service in operative connection with the network; transaction services such as a reader service also in operative connection with the network.

The user interface service is operative to locate transactions and dispensing on the network by invoking a remote lookup service. The user interface service is further operative to invoke methods for remotely controlling the functionality of the dispensing services on the network and for notification when certain events affecting the dispensing services occur.

As can be appreciated from the previous description, the present invention is directed to a vending or dispensing machine which provides for the dispensing of miniature beverage bottles, such as the kind used for selling miniatures of alcoholic drinks which have not typically been considered for use with such dispensing apparatus. However, non-alcoholic mixers also in miniature beverage bottles can also be provided should they be required or desired.

In addition, the present system could readily replace the existing practice of having beverages available within a refrigerator located in a hotel room and as such could minimize or eliminate the need for time consuming recordal of items used by the individual, the daily monitoring of the contents of the refrigerator, and may provide a greater range of beverages, which may appeal to the individual.

Honesty of customers, ensuring appropriate age of customers drinking available alcoholic beverages and so forth may also be more easily monitored within the parameters of this system.

Few existing systems also offer the option of the potential for a wide range of beverages and at the same time have the capacity to hold a reasonable quantity of each type.

Further, security aspects of the dispensing machine provide a range of options from the deterrent effect on theft and vandalism, to hotel security generally, or ensuring only appropriately aged consumers can access the particular beverage types. Offering a breath testing means also provides the consumer with ability to confirm their ability to drive.

Further, having the front panel adapted to be connected to a network system through which items may be shown as advertising or to promote a scenic location and/or be adapted to be used in association with web/cam facilities and the like for providing networked security systems for the vending machines are other potentially beneficial features.

Also having a networked system which can include a local network within a hotel and/or a main control centre where all data is directed and information stored, processed and analysed provides the opportunity to determine a number of parameters, including but not limited to determining consumer preference, the success of advertising, appropriate location of the dispensing machine and so forth. Income from advertising is also another optional benefit.

Therefore, as can be appreciated a variety of different embodiments, uses, and applications of the present invention exist, even within the ambit of the above described dispensing system.

It should also be understood that the term “comprise” where used herein is not to be considered to be used in a limiting sense. Accordingly, ‘comprise’ does not represent nor define an exclusive set of items, but includes the possibility of other components and items being added to the list.

This specification is also based on the understanding of the inventor regarding the prior art. The prior art description should not be regarded as being an authoritative disclosure of the true state of the prior art but rather as referring to considerations in and brought to the mind and attention of the inventor when developing this invention.

Aspects of the present invention have been described by way of example only and it should be appreciated that modifications, additions and variations to and from the above described embodiments may be made without deviating from the scope of the present invention. Aspects of the present invention have been described by way of example only and it should be appreciated that modifications and additions may be made thereto without departing from the scope thereof, as defined in the appended claims.

The claims defining the invention are:

1. Dispensing apparatus for dispensing a variety of a similar item, said dispensing apparatus including a cabinet, said cabinet being adapted to enclose multiple compartments, each compartment capable of retaining multiple substantially similar beverage items; said dispensing apparatus also including dispensing trigger means to trigger release of a preferred item and at least one delivery port where the item is delivered for collection, said dispensing apparatus further including dispensing control assembly configured to offer at least one service from a range of services as defined herein, said dispensing apparatus characterised by the beverage items being miniature bottles capable of holding up to or more than 50 millilitres of a beverage.

2. Dispensing apparatus as claimed in claim 1 wherein the cabinet comprises two spaced apart planar surfaces forming a front and a back wall of the cabinet, two additional planar surfaces at right-angles to the front and back walls and thereby forming side walls of the cabinet, and a further two planar surfaces forming a top and a bottom of the cabinet.

3. Dispensing apparatus as claimed in claim 2 wherein the cabinet includes a stand integral with or adapted to be connected to the cabinet.

4. Dispensing apparatus as claimed in claim 2 wherein the cabinet optionally includes inner partitions to separate the multiple compartments.

5. Dispensing apparatus as claimed in claim 4 wherein each compartment is configured to enable a plurality of beverage containers to be arranged in a stacked relationship, one beverage container being substantially adjacent to at least one other beverage container.

6. Dispensing apparatus as claimed in claim 5 wherein the multiple beverage containers in each compartment are arranged to enable a single beverage container to be dispensed to a delivery port at a time.

7. Dispensing apparatus as claimed in claim 1 wherein the dispensing apparatus also includes security means.

8. Dispensing apparatus as claimed in claim 7 wherein the security means includes one or more of a webcam, audio-security system, tamper alarm used in conjunction with a wireless or wired network to monitor feedback from the security means.

9. Dispensing apparatus as claimed in claim 2 wherein the front wall of the cabinet is transparent.

10. Dispensing apparatus as claimed in claim 9 wherein the transparent front wall enables display of interchangeable static material including advertising, the beverage range available.

11. Dispensing apparatus as claimed in claim 2 wherein the front wall of the cabinet includes a screen capable of receiving and displaying video, CD or film images for advertising purposes or general entertainment.

12. Dispensing apparatus as claimed in claim 11 wherein display of transmitted images to the screen is controlled via a control centre operator for set time periods.

13. Dispensing apparatus as claimed in claim 12 wherein the display of transmitted images is chargeable per unit item or per unit time to provide a source of income from the dispensing machine.

14. Dispensing apparatus as claimed in claim 1 wherein the dispensing apparatus includes at least one funds register.

15. Dispensing apparatus as claimed in claim 14 wherein the funds register is configured to receive deposits of funds in the form of money, currency chips, or electronic charge cards.

16. Dispensing apparatus as claimed in claim 15 wherein the funds register is linked to an integrated network, enabling identification of the purchaser of the items.

17. Dispensing apparatus as claimed in claim 15 wherein deposits of funds into the funds register enables operation of a dispensing trigger.

18. Dispensing apparatus as claimed in claim 15 wherein deposit of funds into the funds register enables operation of a gate mechanism which opens for a defined period or defined distance to allow a single beverage container to be released from the its compartment and towards the delivery port.

19. Dispensing apparatus as claimed in claim 1 wherein the dispensing apparatus includes dispensing control assembly, said dispensing control assembly including a microprocessor programmed to control a range of preferred services, said microprocessor cooperating with an encoder circuit for specific functions and which in turn is programmable, said dispensing control assembly further including interfacing circuits between the microprocessor and other elements of the control system and of the dispensing apparatus itself.

20. Dispensing apparatus as claimed in claim 19 wherein the services offered by the dispensing control assembly include, but are not limited to: the operation of the funds register; generation of the signal allowing activation of the dispensing trigger; operation of the gate mechanism; release of the selected beverage item; programming of the price and location of the item; down-loading of sales records; funds deposited in the funds register to be credited to the user from which current and later purchases can be debited; controlling of the operation of multiple inter-connected dispensing apparata; provision of remedial feedback to any apparatus in instances of malfunction; downloading and comparative analyses of performance based on location, consumer preferences; using data from a single dispensing apparatus or a number of dispensing apparata; security and/or alarm systems including webcam or other visual surveillance and/or auditory systems; advertising displays.

21. Dispensing apparatus as claimed in claim 19 wherein the dispensing control assembly enables control of a system for connecting dispensing services to a network and includes at least one of: a user interface service in operative connection with the network; transaction services such as a reader service also in operative connection with the network.

22. Dispensing apparatus as claimed in claim 21 wherein dispensing control assembly includes any one or more of the following: a card reader, a mainboard, a processor, a network card, a video card, an audio card, speakers built in to the machine, a hard drive, a video screen, a web camera, a breath analyzer, a modem and internet connection or network cabling, a stock of items and advertising media.

23. Dispensing apparatus as claimed in claim 19 wherein dispensing control assembly is programmable to be responsive to appropriate signals received, for energizing displays and relevant driver circuits for dispensing the item, for conversion of a predetermined value of an item in accordance with a selected monetary system, for reporting available credit is insufficient for the item selected, or is insufficient for a refund.

24. Dispensing apparatus as claimed in claim 21 wherein the user interface service is operative to undertake any one or more of locating transactions and dispensing on the network by invoking a remote lookup service; invoking methods for remotely controlling the functionality of the dispensing services on the network and for notification when certain events affecting the dispensing services occur.

25. Dispensing apparatus as claimed in claim 24 wherein when the dispensing apparatus is linked to a network, said dispensing apparatus includes: a processor; said network in operative connection with the processor; and a software component stored in operative connection with the processor, wherein the processor is operative to communicate with at least one other dispensing apparatus, and wherein the processor is responsive to feedback from at least one other dispensing apparatus and/or the network.

26. Dispensing apparatus as claimed in claim 25 wherein the network includes: a data store in operative connection with the processor, a lookup service and a data store associated with the lookup service.
